(19) United States
(12) Patent Application Publication
(10) Pub. No.: US 2014/0223063 A1
(43) Pub. Date: Aug. 7, 2014

(54) USB SSIC REMOVABLE ELECTRONIC DEVICE AND THE ADAPTOR THEREOF

(71) Applicant: Industrial Technology Research Institute, Hsinchu (TW)

(72) Inventors: Chih-Yuan Liu, Hsinchu County (TW); Yuan Heng Sun, New Taipei City (TW); Chien-Hong Lin, Hsinchu County (TW)

(73) Assignee: Industrial Technology Research Institute, Hsinchu (TW)

(21) Appl. No.: 14/144,015

(22) Filed: Dec. 30, 2013

Related U.S. Application Data
(60) Provisional application No. 61/760,782, filed on Feb. 5, 2013.

(30) Foreign Application Priority Data
Dec. 3, 2013 (TW) 102144178

(51) Int. Cl. G06F 13/42; G06F 13/40

(52) U.S. Cl. CPC G06F 13/42; G06F 13/409
USPC 710/301

(57) ABSTRACT

A USB SSIC removable electronic device includes a first receiving terminal pair, a first transmitting terminal pair, a MIPI/SSIC-PHY/Link layer, a function module, at least one power terminal and a ground terminal. The first receiving terminal pair receives data compatible with a USB SSIC interface. The first transmitting terminal pair transmits data compatible with the USB SSIC interface. The MIPI/SSIC-PHY/Link layer receives data compatible with the USB SSIC interface from the first receiving terminal pair, and transmits data compatible with the USB SSIC interface to the first transmitting terminal pair. The function module transmits data with the MIPI/SSIC-PHY/Link layer by the transmission protocol of the USB SSIC interface. The power terminal provides at least one source voltage for the MIPI/SSIC-PHY/Link layer and the function module.

### CROSS REFERENCE TO RELATED APPLICATION

This application claims the benefit of U.S. Provisional Application No. 61/760,782, filed Feb. 5, 2013, the entirety of which is incorporated by reference herein. Furthermore, this Application also claims priority of Taiwan Patent Application No. 102144178, filed on Dec. 3, 2013, the entirety of which is incorporated by reference herein.

### TECHNICAL FIELD

The disclosure relates to a removable electronic device and an adapter device of the removable electronic device; and in particular to an USB SSIC removable electronic device and an adapter device of the removable electronic device which are compatible with USB SSIC interface.

### BACKGROUND

Recently, with vigorous development of computers and the communications industry, various peripheral devices can easily be connected to a host device such as a personal computer (PC), a notebook PC, and so on, including Internet and external storage devices, and so on. Usually, users need to transmit data from the peripheral device to the host, or transmit data from the host to the peripheral device, but the transmission speed and power requirement of the peripheral device during the transmission are limited by the interface. example, the power requirement of the USB interface is too high for the mobile devices. Therefore a memory or functional card with a USB interface is not the best option for mobile devices.

### SUMMARY

An exemplary embodiment provides an USB SSIC removable electronic device with a first surface. The removable electronic device includes a first receiving terminal pair, a first transmitting terminal pair, an MIPI/SSIC-PHY/Link layer, a function module, at least one power terminal and a ground terminal. The first receiving terminal pair is arranged to receive data compatible with a transmission protocol of an USB SSIC interface. The first transmitting terminal pair is arranged to transmit data compatible with the transmission protocol of the USB SSIC interface. The MIPI/SSIC-PHY/Link layer is arranged to be coupled to the first receiving terminal pair and the first transmitting terminal pair, receive data compatible with the transmission protocol of USB SSIC interface from the first receiving terminal pair, and transmit data compatible with the transmission protocol of USB SSIC interface to the first transmitting terminal pair. The function module is arranged to be coupled to the MIPI/SSIC-PHY/Link layer, and transmit data with the MIPI/SSIC-PHY/Link layer by the transmission protocol of USB SSIC interface. The at least one power terminal is arranged to provide at least one source voltage for the MIPI/SSIC-PHY/Link layer and the function module for operating. The first receiving terminal pair, the first transmitting terminal pair, the power terminal and the ground terminal are arranged along a first axis on the first surface.

Another exemplary embodiment provides an adapter device. The adapter device includes a slot, an SSIC pin set, a first interface pin set, an interface converting device and a power regulator. The slot is arranged to contain an USB SSIC removable electronic device compatible with an USB SSIC interface, and the removable electronic device comprises a plurality of terminals. The SSIC pin set is arranged in the slot, and coupled to the plurality of terminals. The first interface pin set is compatible with a first interface. The interface converting device is coupled to the SSIC pin set and the first interface pin set, and arranged to convert data of the first face into data compatible with a transmission protocol of the USB SSIC interface and convert data compatible with the transmission protocol of USB SSIC interface into data compatible with a transmission protocol of the first interface. The power regulator is arranged to receive at least one input voltage compatible with the transmission protocol of first interface, and convert the input voltage into at least one source voltage compatible with transmission protocol of the USB SSIC interface.

### BRIEF DESCRIPTION OF DRAWINGS

The present disclosure can be more fully understood by reading the subsequent detailed description and examples with references made to the accompanying drawings, wherein:

FIG. 1 is a schematic view of an USB SSIC removable system according to an exemplary embodiment;

FIG. 2A is a schematic view of an USB SSIC removable electronic device according to an exemplary embodiment;

FIG. 2B is a top view and a side view of the removable electronic device of FIG. 2A according to an exemplary embodiment;

FIG. 3A is a schematic view of an USB SSIC removable electronic device according to another exemplary embodiment;

FIG. 3B is a top view and a side view of the removable electronic device of FIG. 3A according to an exemplary embodiment;

FIG. 4 is a schematic view of an adapter device according to an exemplary embodiment; and

FIG. 5 is a schematic view of an adapter device according to another exemplary embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

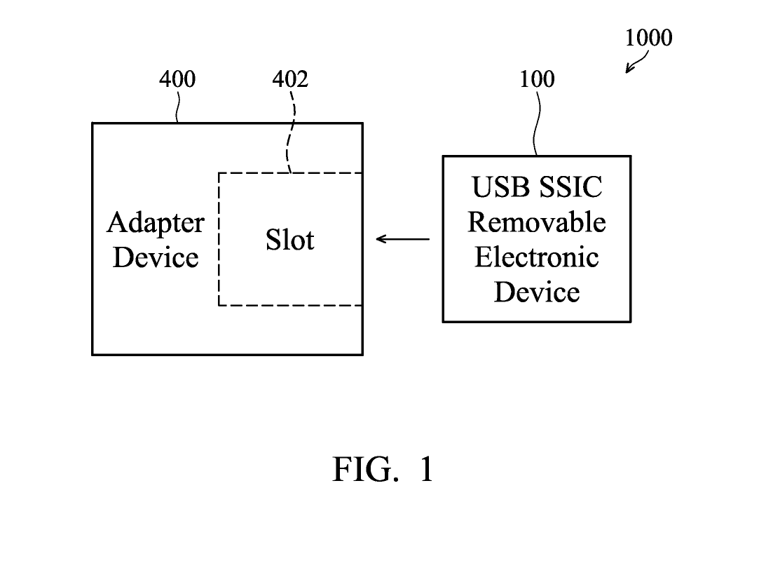

FIG. 1 is a schematic view of an USB SSIC(Super Speed Inter-Chip) removable system according to an exemplary embodiment. The USB SSIC removable system 1000 includes an USB SSIC removable electronic device 100 and an adapter device 400. The adapter device 400 has a slot 402 and the removable electronic device 100 is arranged to be contained in the slot 402. The removable electronic device 100 is arranged to transmit and receive data by the transmission protocol of the USB SSIC interface. The adapter device 400 is arranged to convert the data compatible with the transmission protocol of the USB SSIC interface of the removable electronic device 100 into data compatible with the transmission protocol of a first interface to transmit to a host (not shown), and vice versa convert the data compatible with the transmission protocol of the first interface of the host into the data compatible with the transmission protocol of the USB SSIC interface to transmit to the removable electronic device 100. In one of the embodiments, the first interface is Universal Serial Bus 3.0 interface (USB 3.0). In another embodiment, the first interface is a Universal Serial Bus 2.0 (USB 2.0) interface, but it is not limited thereto. It should be noted that the specification of Protocol Layer of the USB SSIC interface is same as the specification of Protocol Layer of the USB interface, the specification of PHY layer (Physical Layer) of the USB interface is different from the specification of PHY layer of USB SSIC interface, and the specification of Link layer of the USB interface is different from the specification of Link layer of the USB SSIC interface.

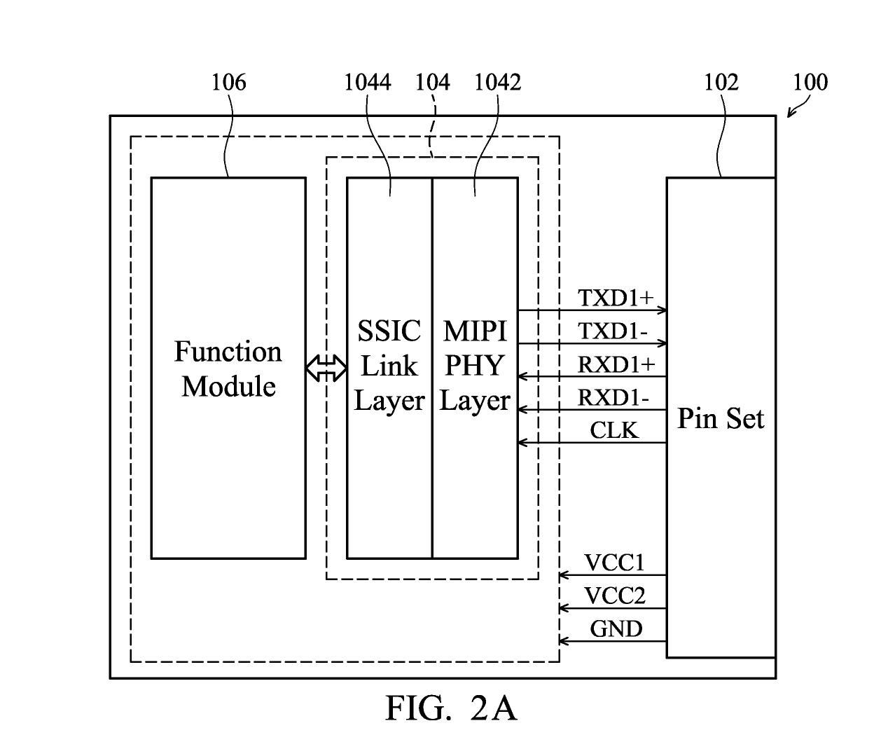

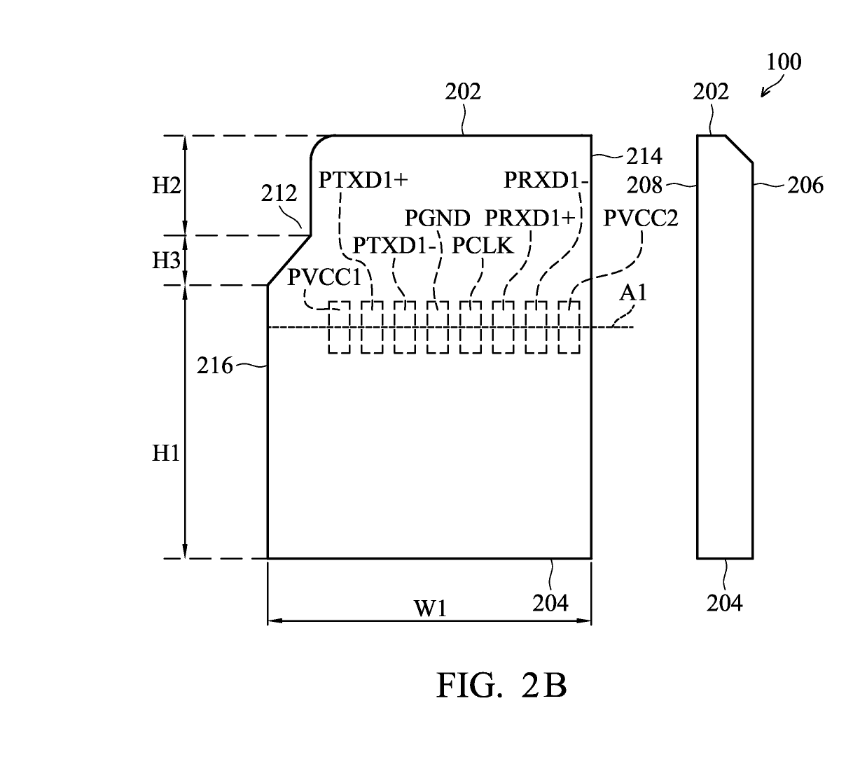

FIG. 2A is a schematic view of a removable electronic device according to an exemplary embodiment. The removable electronic device 100 includes a pin set 102, an MIPI/SSIC-PHY/Link layer (MIPI: Mobile Industry Processor Interface) 104 and a function module 106. In this embodiment, the pin set 102 includes a first receiving terminal pair, a first transmitting terminal pair, a clock terminal, at least one power terminal and a ground terminal, but it is not limited thereto.

The first receiving terminal pair is arranged to receive the data RXD1+ and RXD1− which are compatible with the transmission protocol of the USB SSIC interface. The first transmitting terminal pair is arranged to transmit the data TXD1+ and TXD1− which are compatible with the transmission protocol of the USB SSIC interface. The power terminal is arranged to receive at least one source voltage which is arranged to provide to the MIPI/SSIC-PHY/Link layer 104 and the function module 106 for regular operating. In one of the embodiments, the pin set 102 has two power terminals including a first power terminal and a second power terminal, the first power terminal and the second power terminal are arranged to receive a first voltage VCC1 and a second voltage VCC2, respectively, and the first voltage VCC1 and the second voltage VCC2 are arranged to provide the operating voltage for the different elements of the MIPI/SSIC-PHY/Link layer 104 and the function module 106. Furthermore, the mechanism of using two different voltages (VCC1 and VCC2) in different operating elements can improve work efficiency. In this embodiment, the first voltage terminal is arranged to receive a core voltage (Vcore), and the second voltage terminal is arranged to receive an I/O voltage (Vio). In other words, the first voltage VCC1 is the core voltage (Vcore), and the second voltage VCC2 is the I/O voltage (Vio), but it is not limited thereto. In other embodiments, the pin set 102 may have one power terminal. For example, the core voltage (Vcore) can be 2 volts, 3.9 volts, or any rational number between 2-3.9 can be regarded as the core voltage. The I/O voltage (Vio) can be 0.6 volts, 1.9 volts, or any rational number between 0.6-1.9 can be regarded as the I/O voltage. The clock terminal is arranged to receive a clock signal CLK arranged to be provided to the MIPI/SSIC-PHY/Link layer 104 and the function module 106. It should be noted that, in one of the embodiments, the pin set 102 may not include the clock terminal. The ground terminal is arranged to be connected to a ground GND.

The MIPI/SSIC-PHY/Link layer 104 is coupled to the first receiving terminal pair and the first transmitting terminal pair of the pin set 102. The MIPI/SSIC-PHY/Link layer 104 is arranged to receive the data RXD1+ and RXD1− which are compatible with the transmission protocol of the USB SSIC interface through the first receiving terminal pair, and transmit the data RXD1+ and RXD1− which are compatible with the transmission protocol of the USB SSIC interface to the function module 106. Moreover, the MIPI/SSIC-PHY/Link layer 104 is arranged to receive the data TXD1+ and TXD1− which are compatible with the transmission protocol of the USB SSIC interface from the function module 106, and transmit the data TXD1+ and TXD1− which are compatible with the transmission protocol of the USB SSIC interface to the first transmitting terminal pair. It should be noted that the MIPI/SSIC-PHY/Link layer 104 includes an MIPI PHY Layer 1042 and a SSIC Link layer 1044, wherein the power requirement of the MIPI PHY Layer 1042 of SSIC is lower than the PHY layer of USB.

The function module 106 is coupled to the MIPI/SSIC-PHY/Link layer 104, and the function module 106 is arranged to transmit data with the MIPI/SSIC-PHY/Link layer 104 by transmission protocol compatible with the USB SSIC interface. It should be noted that the specification of the protocol Layer of the USB SSIC interface is same as the protocol layer of the USB interface, the specification of the PHY layer (Physical Layer) of USB interface is different from the specification of the PHY layer of the USB SSIC interface, and the specification of the Link layer of the USB interface is different from the specification of the Link layer of the USB SSIC interface. In one embodiment, the function module 106 can be a memory module. The memory module includes a memory controller and a memory, but it is not limited thereto. The function module 106 can also be a wireless module, a bluetooth module, a near field communication module (NFC), a mobile communication module (3G/4G, LTE) and an I/O module.

FIG. 2B is a top view and a side view of the USB SSIC removable electronic device of FIG. 2A according to an exemplary embodiment. In this embodiment, the removable electronic device 100 can be a thin card. The removable electronic device 100 includes a card body. The card body has a front edge 202, a trailing edge 204, a first surface 208 and a second surface 206. Moreover, the card body has a groove 212, a first side edge 214 and a second side edge 216. The first side edge 214 is parallel to the second side edge 216, and arranged to connect the front edge 202 and the trailing edge 204. The groove 212 is arranged on a corner between the front edge 202 and second side edge 216, that is a corner of the first surface 208, as shown in FIG. 2B. It should be noted that the length H2 of the groove 212 is 3.05 millimeters, a bevel edge between the connect the groove 212 and the second side edge 216 is arranged to connect the groove 212 and the second side edge 216, the length H3 of vertical distance between the groove 212 and the second side edge 216 is 1.35 millimeters, but it is not limited thereto. Moreover, the sum of the lengths H1, H2 and H3 is 15 millimeters, but it is not limited thereto. The width W1 of the trailing edge 204 is 11 millimeters. It should be noted that the sum of lengths H1, H2 and H3 and the width W1 is compatible with the Micro SD card. The first receiving terminal pair PRXD1+ and PRXD1−, the first transmitting terminal pair PTXD1+ and PTXD1−, the power terminal PVCC1 and PVCC2, the clock terminal PCLK and ground terminal PGND of the pin set are arranged along a first axis Al on the first surface 208 and near the middle portion of the first surface 208. In other embodiments, the pin set 102 may not include the clock terminal PCLK and/or the power terminal PVCC2. Moreover, in one of the embodiments, the pin set 102 not only includes the eight terminals, but also includes further includes a ninth terminal arranged along the first axis.

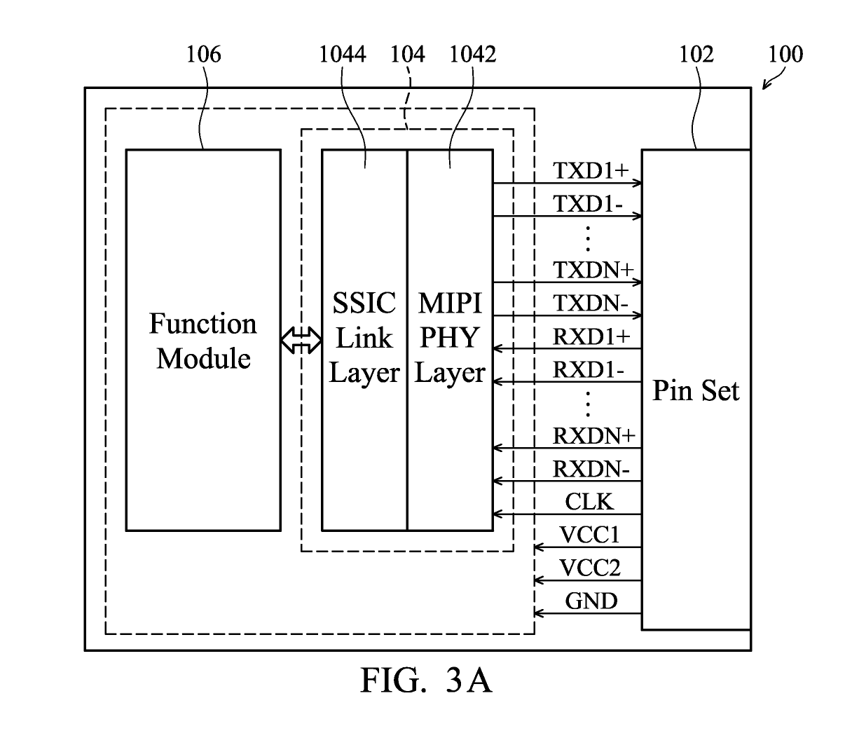

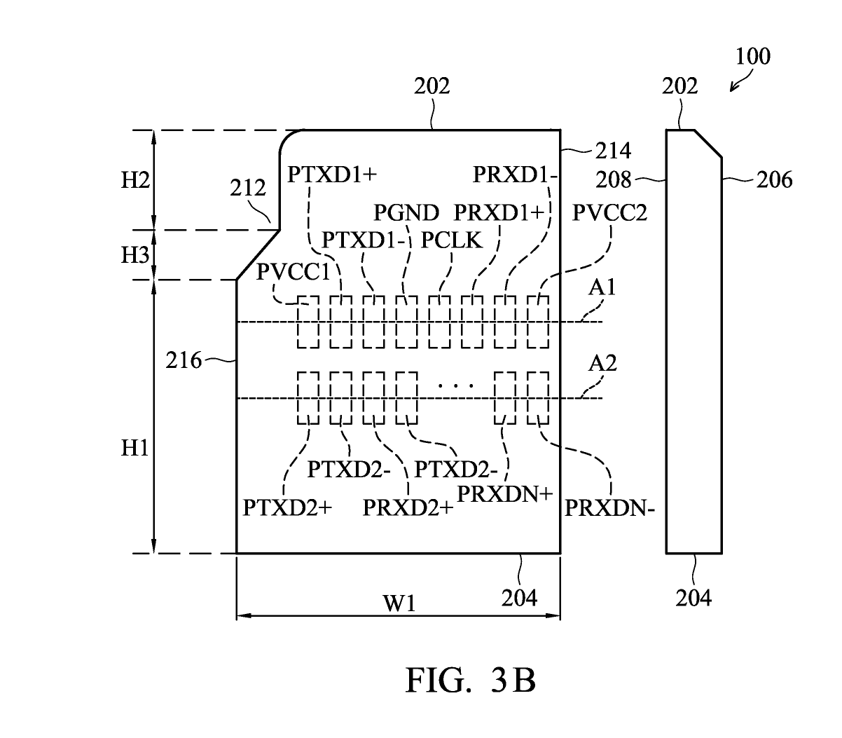

FIG. 3A is a schematic view of an USB SSIC removable electronic device according to another exemplary embodiment. The removable electronic device 100 of FIG. 3A is similar to the removable electronic device 100 of FIG. 2A except for the pin set 102. In this embodiment, the pin set 102 not only includes the first receiving terminal pair, the first transmitting terminal pair, and clock terminal, the at least one power terminal and a ground terminal, but also at least one second receiving terminal pair and at least one second transmitting terminal pair

The second receiving terminal pair is similar to the first receiving terminal pair and the second transmitting terminal pair is similar to the first transmitting terminal pair, wherein the second receiving terminal pair is arranged to receive the data RXD2+˜RXDN+ and RXD2−˜RXDN− which are compatible with the transmission protocol of the USB SSIC interface, and the second transmitting terminal pair is arranged to transmit the data TXD2+˜TXDN+ and TXD2−˜TXDN− which are compatible with the transmission protocol of the USB SSIC interface. Moreover, the details of the power terminal, the clock terminal and the ground terminal can be referred to in FIG. 2A.

The MIPI/SSIC-PHY/Link layer 104 is coupled to the first receiving terminal pair, the second receiving terminal pair, the first transmitting terminal pair and the second transmitting terminal pair of the pin set 102. The MIPI/SSIC-PHY/Link layer 104 is arranged to receive the data RXD1+˜RXDN+ and RXD1−˜RXDN− which are compatible with the transmission protocol of the USB SSIC interface through the first receiving pair and the second receiving terminal pair, and transmit the data RXD1+˜RXDN+ and RXD1−˜RXDN− which are compatible with the transmission protocol of the USB SSIC interface to the function module 106. Moreover, the MIPI/SSIC-PHY/Link layer 104 is further arranged to receive the data TXD1+˜TXDN+ and TXD1−˜TXDN− which are compatible with the transmission protocol of the USB SSIC interface from the function module 106, and transmit the data TXD1+˜TXDN+ and TXD1−˜TXDN− which are compatible with the transmission protocol of the USB SSIC interface to the first transmitting terminal pair and the second transmitting terminal pair. It should be noted that the MIPI/SSIC-PHY/Link layer 104 includes an MIPI PHY Layer 1042 and a SSIC Link layer 1044, wherein the power requirement of the MIPI PHY Layer 1042 of the USB SSIC interface is lower than that of the PHY layer of the USB interface. Moreover, the details of the function module 106 can be referred to in FIG. 2A.

FIG. 3B is a top view and a side view of the USB SSIC removable electronic device of FIG. 3A according to an exemplary embodiment. The removable electronic device 100 of FIG. 3B is similar to the removable electronic device 100 of FIG. 2A except that the removable electronic device 100 of FIG. 3B further includes at least one second receiving terminal pair PRXD2+˜PRXDN+ and PRXD2−˜PRXDN− and at least one second transmitting terminal pair PTXD2+˜PTXDN+ and PTXD2−˜PTXDN−. The second receiving terminal pair PRXD2+˜PRXDN+ and PRXD2−˜PRXDN− and the second transmitting terminal pair PTXD2+˜PTXDN+ and PTXD2−˜PTXDN− are arranged along a second axis A2 on the first surface 208 near the first axis A1, wherein the second axis A2 is parallel to the first axis A1, and the first axis A1 is disposed between the front edge 202 and the second axis A2. It should be noted that, in one embodiment, the first receiving terminal pair PRXD1+ and PRXD1−, the first transmitting terminal pair PTXD1+ and PTXD1−, the power terminal PVCC1, the PVCC2 and the ground terminal PGND arranged along the first axis A1 are staggered with the second receiving terminal pair PRXD2+˜PRXDN+ and PRXD2−˜PRXDN− and the second transmitting terminal pair PTXD2+˜PTXDN+ and PTXD2−˜PTXDN− arranged along the second axis A2. The other details can be referred to in FIG. 2B.

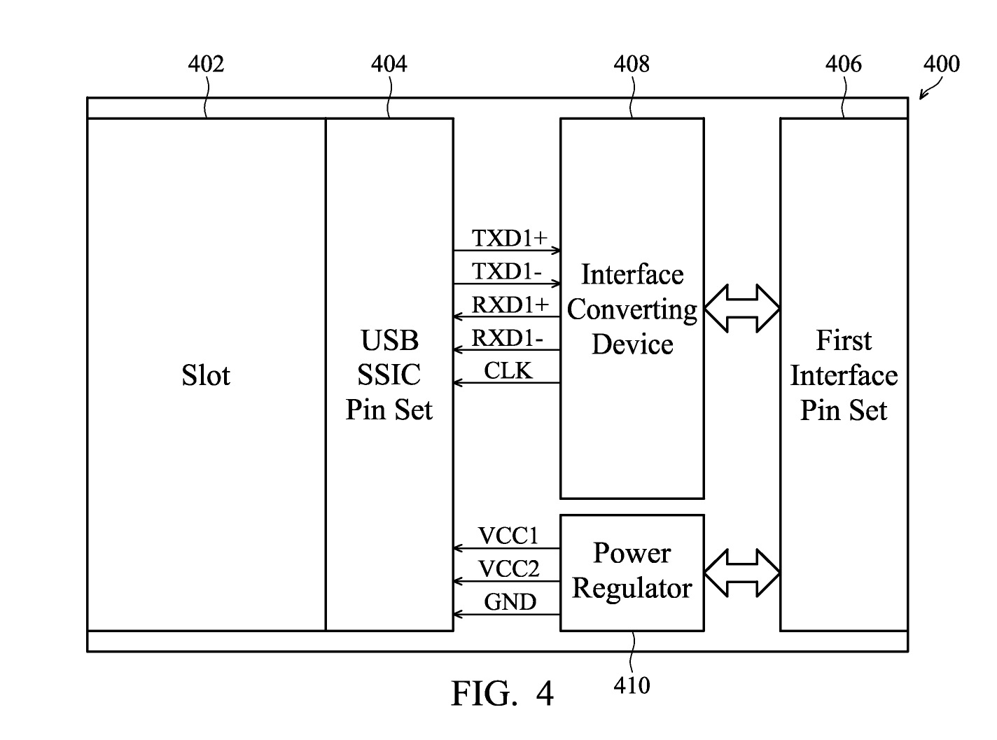

FIG. 4 is a schematic view of an adapter device according to an exemplary embodiment. The adapter device 400 includes a slot 402, a SSIC pin set 404, a first interface pin set 406, an interface converting device 408 and a power regulator 410. The adapter device 400 is arranged to plug into a slot compatible with the first interface of a host (not shown), wherein the adapter device 400 is arranged to convert the data of the first interface and the USB SSIC interface, such that the removable electronic device 100 can exchange data with the host. In one embodiment, the first interface is a Universal Serial Bus 3.0 interface (USB 3.0). In another embodiment, the first interface can be Universal Serial Bus 2.0 (USB 2.0) interface, but it is not limited thereto. It should be noted that the specification of Protocol Layer of the USB SSIC interface is same as the specification of Protocol Layer of the USB interface, the specification of the PHY layer (Physical Layer) of the USB interface is different from the specification of the PHY layer of the USB SSIC interface, and the specification of the Link layer of the USB interface is different from the specification of the Link layer of the USB SSIC interface.

The slot 402 is arranged to contain the removable electronic device 100 compatible with the USB SSIC interface, as shown in FIG. 1-3B. It should be noted that those skilled in the art will recognize the design rule of the slot 402 by the descriptions of FIG. 2B and 3B, but it is not limited thereto.

The SSIC pin set 404 is arranged inside of the slot 402, wherein the SSIC pin set 404 is arranged to couple to the pin set 102 of the removable electronic device 100. In this embodiment, the SSIC pin set 404 includes a first receiving pin pair, a first transmitting pin pair, at least one power pin and a clock pin, but it is not limited thereto. The first receiving pin pair is arranged to be coupled to the first receiving terminal pair PRXD1+ and PRXD1− of the removable electronic device 100 for receiving the data RXD1+ and RXD1− which are compatible with the transmission protocol of the USB SSIC interface from the interface converting device 408 and transmitting the data RXD1+ and RXD1− which are compatible with the transmission protocol of the USB SSIC interface to the removable electronic device 100. The first transmitting pin pair is arranged to be coupled to the first transmitting terminal pair PTXD1+ and PTXD1− of the removable electronic device 100 for transmitting the data TXD1+ and TXD1− received from the removable electronic device 100 to the interface converting device 408. At least one power pin(s) is(s) arranged to contact the power terminal PVCC1 and PVCC2 of the removable electronic device 100 for providing at least one source voltage produced by the power regulator 410 to the removable electronic device 100. In one of the embodiments, the SSIC pin set 404 includes two power pins, such as the first power pin and the second power pin, but it is not limited thereto. The clock pin is arranged to electronically contact with the clock terminal PCLK of the removable electronic device 100 for providing a clock signal CLK to the removable electronic device 100. It should be noted that, in one embodiment, the SSIC pin set 404 may not include the clock pin, but it is not limited thereto. The ground pin is arranged to be connected to a ground GND. Moreover, those skilled in the art will recognize the design rule of the position of the SSIC pin set 404 of the slot 402 by the descriptions of FIG. 2B and 3B, but it is not limited thereto. For example, the first receiving pin pair, the first transmitting pin pair, the power pin, the clock pin and the ground pin are arranged along a first axis inside of the slot 402.

The first interface pin set 406 is arranged to be electronically connected with the host. Those skilled in the art can design the layout of the first interface pin set 406 to the specification of the first interface, but it is not limited thereto. For example, when the first interface is a USB 2.0 interface, the first interface pin set 406 has four pins with predetermined positions. When the first interface is the USB 3.0 interface, the first interface pin set 406 has nine pins with predetermined positions, but it is not limited thereto.

The interface converting device 408 is coupled between the SSIC pin set 404 and the first interface pin set 406, wherein the interface converting device 408 is arranged to convert the data compatible with a transmission protocol of the first interface and received from the host into data RXD1+ and RXD1− compatible with the transmission protocol of the USB SSIC interface for providing the converted data to the removable electronic device 100, and the interface converting device 408 is further arranged to convert the data TXD1+ and TXD1− which are compatible with the transmission protocol of the USB SSIC interface and received from the removable electronic device 100 into data compatible with a transmission protocol of the first interface for providing the converted data to the host. It should be noted that, in some embodiments, the interface converting device 408 is further arranged to produce the clock signal CLK compatible with the transmission protocol of the USB SSIC interface.

The power regulator 410 is arranged to receive at least one input voltage compatible with the first interface, and convert the input voltage into at least one source voltage compatible with the USB SSIC interface for providing the source voltage to the removable electronic device 100 through the SSIC pin set 404. In one embodiment, the power regulator 410 is arranged to convert the input voltage into a first voltage VCC1 and a second voltage VCC2 to provide the first voltage VCC1 and the second voltage VCC2 to the removable electronic device 100 through the first power pin and the second power pin of the at least one power pin. For example, the first voltage VCC1 is a core voltage (Vcore), and the second voltage VCC2 is the I/O voltage (Vio), but it is not limited thereto. In other the pin set 102 may have only one power terminal. For example, the core voltage (Vcore) can be 2 volts, 3.9 volts, or any rational number between 2-3.9 can be regarded as the value of the core voltage. The I/O voltage (Vio) can be 0.6 volt, 1.9 volt, or any rational number between 0.6-1.9 can be used for the volt number of the I/O voltage.

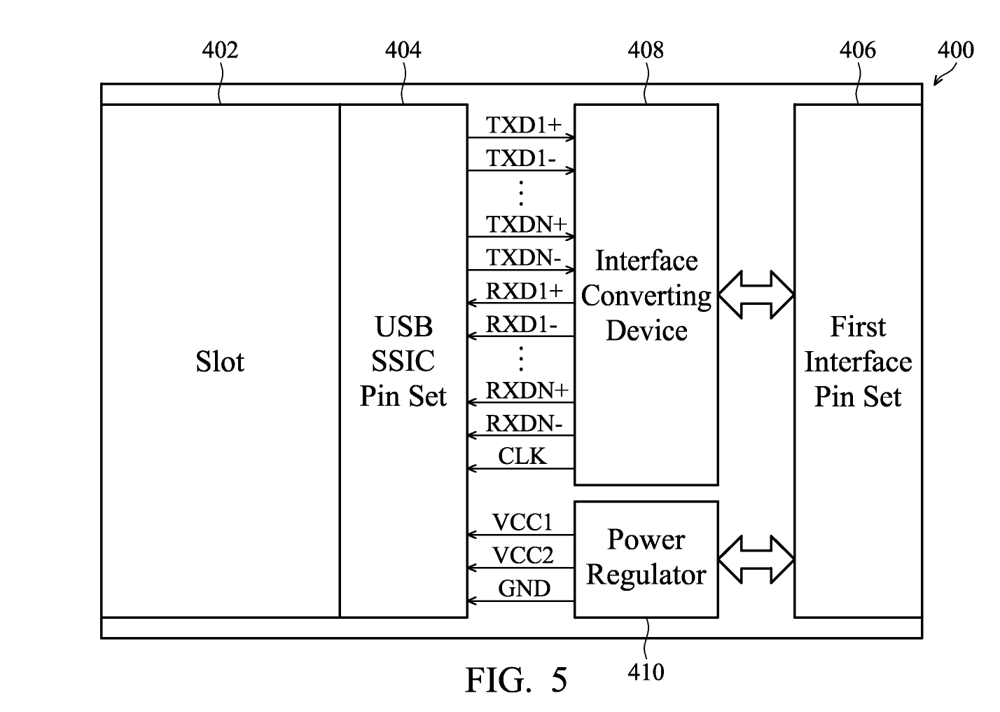

FIG. 5 is a schematic view of an adapter device according to another exemplary embodiment. The adapter device 400 of FIG. 5 is similar to the adapter device 400 of FIG. 4 except for the SSIC pin set 404.

The SSIC pin set 404 not only includes the first receiving pin pair, the first transmitting pin pair, the at least one power pin and the clock pin, but also includes at least one second receiving pin pair and at least one second transmitting pin pair. The at least one second receiving pin pair is similar to the at least one first receiving pin pair, the second receiving pin pair is arranged to electronically contact with the at least one second receiving terminal pair PRXD2+˜PRXDN+ and PRXD2−˜PRXDN− of the removable electronic device 100 for receiving the data RXD2+˜RXDN+ and RXD2−˜RXDN− which are compatible with the transmission protocol of the USB SSIC interface from the interface converting device 408 and transmitting the data RXD2+˜RXDN+ and RXD2−˜RXDN− which are compatible with the transmission protocol of the USB SSIC interface to the removable electronic device 100. The at least one second transmitting pin pair is similar to the at least one first transmitting pin pair, the at least one second transmitting pin pair is arranged to electronically contact with the at least one second transmitting terminal pair PTXD2+˜PTXDN+ and PTXD2−˜PTXDN− of the removable electronic device 100 for transmitting the data TXD2+˜TXDN+ and TXD2−˜TXDN− which are compatible with the transmission protocol of the USB SSIC interface and received from the removable electronic device 100 to the interface converting device 408.

The interface converting device 408 is coupled between the SSIC pin set 404 and the first interface pin set 406, and arranged to conver the data which is compatible with the protocol of the first interface and received from the host into data RXD1+˜RXDN+ and RXD1−˜RXDN− which are compatible with the transmission protocol of the USB SSIC interface for providing the converted data to the removable electronic device 100, and convert the data TXD1+˜TXDN+ and TXD1−˜TXDN− which are compatible with the transmission protocol of the USB SSIC interface and received from the removable electronic device 100 into data which is compatible with the protocol of the first interface for providing the host. It should be noted that the interface converting device 408 is further arranged to produce a clock signal CLK compatible with the USB SSIC interface. The other details can be referred to in FIG. 4.

The USB SSIC removable electronic device 100 of the embodiments may access data with higher speed (a single lane may reach 5 Gbps, and the speed of a multi-lane is a few times faster than the single lane according to the number of lane) by the USB SSIC interface. Furthermore, the layout of the removable electronic device 100 is compatible with the slot of Micro SD card, and the adapter device 400 can convert the data from the USB SSIC interface into data compatible with other interfaces.

Any data transmission methods, portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An USB SSIC removable electronic device having a first surface, comprising:
a first receiving terminal pair, arranged to receive data compatible with a transmission protocol of an USB SSIC interface;
a first transmitting terminal pair, arranged to transmit data compatible with the transmission protocol of the USB SSIC interface;
an MIPI/SSIC-PHY/Link layer, coupled to the first receiving terminal pair and the first transmitting terminal pair, is arranged to receive data compatible with the transmission protocol of the USB SSIC interface from the first receiving terminal pair, and transmit data compatible with the transmission protocol of USB SSIC interface to the first transmitting terminal pair;
a function module, coupled to the MIPI/SSIC-PHY/Link layer, is arranged to transmit/receive data to/from the MIPI/SSIC-PHY/Link layer with the transmission protocol of USB SSIC interface;
at least one power terminal, arranged to provide at least one source voltage to the MIPI/SSIC-PHY/Link layer and the function module for operating; and
a ground terminal;
wherein the first receiving terminal pair, the first transmitting terminal pair, the power terminal and the ground terminal are arranged along a first axis on the first surface.

2. The removable electronic device as claimed in claim 1, further comprising:
at least one second receiving terminal pair, arranged to receive data compatible with the transmission protocol of USB SSIC interface; and
at least one second transmitting terminal pair, arranged to transmit data compatible with the transmission protocol of USB SSIC interface;
wherein the MIPI/SSIC-PHY/Link layer is further coupled to the second receiving terminal pair and the second transmitting terminal pair, and arranged to receive data compatible with the transmission protocol of USB SSIC interface from the second receiving terminal pair and transmit data compatible with the transmission protocol of USB SSIC interface to the second transmitting terminal pair.

3. The removable electronic device as claimed in claim 2, wherein the second receiving terminal pair and the second transmitting terminal pair are arranged along a second axis on the first surface, and the second axis is parallel with the first axis.

4. The removable electronic device as claimed in claim 3, wherein the first receiving terminal pair, the first transmitting terminal pair, the power terminal and the ground terminal arranged along the first axis are staggered individually with the second receiving terminal pair and the second transmitting terminal pair, which are arranged along the second axis.

5. The removable electronic device as claimed in claim 1, further comprising a groove, and the groove is arranged at a corner of the first surface.

6. The removable electronic device as claimed in claim 1, wherein the length (H1+H2+H3) and the width (W1) of the removable electronic device are compatible with the specification of Micro SD card.

7. The removable electronic device as claimed in claim 1, wherein the MIPI/SSIC PHY/Link layer further comprises:
an MIPI PHY layer; and
an SSIC Link layer.

8. The removable electronic device as claimed in claim 1, wherein the at least one power terminal comprises a first voltage terminal and a second voltage terminal, the first voltage terminal is arranged to receive a core voltage (Vcore), and the second voltage terminal is arranged to receive an I/O voltage (Vio).

9. The removable electronic device as claimed in claim 1, further comprising a clock terminal arranged to provide a clock signal for the MIPI/SSIC-PHY/Link layer and the function module.

10. The removable electronic device as claimed in claim 1, wherein the function module is a memory module which further comprises a memory controller and a memory.

11. The removable electronic device as claimed in claim 1, wherein the function module is one of a wireless module, a bluetooth module, a near field communication module(NFC), a mobile communication module(3G/4G, LTE) and an I/O module.

12. An adapter device, comprising:
a slot, arranged to contain a removable electronic device compatible with an USB SSIC interface, and the removable electronic device comprises a plurality of terminals;
an SSIC pin set, arranged in the slot, and is coupled to the plurality of terminals;
a first interface pin set, compatible with a first interface;
an interface converting device, coupled to the SSIC pin set and the first interface pin set, and is arranged to convert data of the first interface into data compatible with a transmission protocol of the USB SSIC interface and convert data compatible with the transmission protocol of the USB SSIC interface into data compatible with a transmission protocol of the first interface; and
a power regulator, arranged to receive at least one input voltage compatible with the transmission protocol of the first interface, and convert the input voltage into at least one source voltage compatible with the transmission protocol of the USB SSIC interface.

13. The adapter device as claimed in claim 12, wherein the SSIC pin set comprises:
a first receiving pin pair, arranged to receive data compatible with the transmission protocol of the USB SSIC interface;
a first transmitting pin pair, arranged to transmit data compatible with the transmission protocol of the USB SSIC interface;
at least one power pin, arranged to transmit the source voltage; and
a ground pin.

14. The adapter device as claimed in claim 13, wherein the first receiving pin pair, the first transmitting pin pair, the power pin and the ground pin are arranged along a first axis in the slot.

15. The adapter device as claimed in claim 14, wherein the SSIC pin set further comprises:
at least one second receiving pin pair, arranged to receive data compatible with the transmission protocol of USB SSIC interface; and
at least one second transmitting pin pair, arranged to transmit data compatible with the transmission protocol of USB SSIC interface.

16. The adapter device as claimed in claim 13, wherein the power regulator is arranged to convert the input voltage into a core voltage (Vcore) and an I/O voltage (Vio) for providing separately the core voltage and the I/O voltage through a first power pin and a second power pin of the power pins.

17. The adapter device as claimed in claim 12, wherein the SSIC pin set further comprises a clock pin arranged to provide a clock signal.

18. The adapter device as claimed in claim 12, wherein the specification of protocol layer of the first interface is same as the specification of protocol layer of the USB SSIC interface, the specification of PHY layer of the first interface is different from the specification of PHY layer of the USB SSIC interface, and the specification Link layer of the first interface is different from the specification of Link layer of the USB SSIC interface.

19. The adapter device as claimed in claim 12, wherein the first interface is a Universal Serial Bus (USB) interface.

20. The adapter device as claimed in claim 15, wherein the second receiving pin pair and the second transmitting pin pair is arranged along a second axis in the slot, and the second axis is parallel to the first axis.
